(19) United States
(12) Patent Application Publication
(10) Pub. No.: US 2014/0318211 A1
(43) Pub. Date: Oct. 30, 2014

(54) POSITIVE DISPLACEMENT CALIBRATION TOOL FOR CALIBRATING MASS FLOW CONTROLLERS IN A PRINTING APPARATUS

(71) Applicant: E I DU PONT DE NEMOURS AND COMPANY, Wilmington, DE (US)

(72) Inventor: JAMES DANIEL TREMEL, Santa Barbara, CA (US)

(73) Assignee: E I DU PONT DE NEMOURS AND COMPANY, Wilmington, DE (US)

(21) Appl. No.: 14/253,283

(22) Filed: Apr. 15, 2014

Related U.S. Application Data
(60) Provisional application No. 61/815,847, filed on Apr. 25, 2013.

(51) Int. Cl. G01F 25/00

(52) U.S. Cl. CPC G01F 25/0007
USPC 73/1.19

(57) ABSTRACT

A positive displacement calibration tool useful for simultaneously calibrating a plurality of flow meters, the tool comprising: a frame; a housing block having a plurality of fluid chambers therein, each fluid chamber being connectible to a respective liquid flow line, each chamber having an axis therethrough, the axis of each fluid chamber being aligned within a predetermined close tolerance with the axis of each of the other fluid chambers formed in the block; a piston mounted within the block for movement within each fluid chamber; and an actuator connected to all of the pistons whereby the actuator is operative to displace each piston through its associated chamber to cause a precisely dispensed predetermined flow rate of a liquid to pass simultaneously from each chamber.

### CROSS REFERENCE TO RELATED APPLICATIONS

Subject matter disclosed herein is disclosed and claimed in the following copending applications, filed contemporaneously herewith and assigned to the assignee of the present invention: Method For Calibrating Mass Flow Controllers In A Printing Apparatus For Dispensing A Liquid Composition On A Backplane (UC-1033).

### FIELD OF THE INVENTION

This invention relates to a printing apparatus for dispensing a liquid composition on a surface, such as the dispensing of a liquid composition containing an organic semiconductor material on a backplane, and particularly to a system and corresponding method for calibrating the flow meter in a flow controller monitoring the dispensed flow of the liquid composition and, in another particular aspect, to a calibration tool useful in implementing the calibration system and method.

### DESCRIPTION OF THE RELATED ART

Organic electronic devices utilizing organic active materials are used in many different kinds of electronic equipment. The term “organic electronic device” is intended to mean a device, such as an organic light emitting diode (OLED), that includes one or more layers of organic semiconductor materials laminated between other supporting layers and sandwiched by two electrodes.

Current manufacture of organic electronic devices utilizes a vapor phase deposition process to deposit organic semiconductor materials. However, vapor phase deposition is believed to be disadvantageous owing to its poor utilization of materials. In vapor phase deposition a mask is used to control precise deposition of each layer of organic semiconductor material. The open areas of the mask allow material to adhere to desired areas of the underlying substrate. However, the solid portions of the mask become coated with organic semiconductor material during production of each layer and do not reach the substrate. This is seen as wasteful of the organic materials. In addition, masks must be replaced after only a few production cycles to maintain deposition quality. Scaling of the vapor phase deposition to larger electronic devices is problematic and expensive. In view of these perceived difficulties liquid deposition of organic semiconductor materials is seen as an advantageous alternative.

Each organic material is carried in a liquid composition. During manufacture of a device each liquid composition is dispensed from a dedicated nozzle carried by a dispensing bar. The nozzles are grouped in nozzle sets, with one nozzle in each set dispensing a particular color of ink. Each nozzle dispenses liquid and deposits that liquid along a longitudinal lane that extends across a backplane of the device. The nozzles in each set continuously dispense a liquid composition into a respective lane as the bar traverses the backplane.

The dispensing bar usually carries a plurality of sets of dispensing nozzles, alternatively described as a set of nozzles, with each set of nozzles including a separate nozzle that discharges one of a plurality of differently colored liquid compositions. For example, in a typical instance, the dispensing bar may carry five nozzle sets, with each nozzle set including a nozzle for dispensing a red, a green and a blue liquid composition. The individual nozzles for each particular color in each nozzle set are supplied as a group through a manifold that is itself supplied from a communal supply vessel for that color. The flow of liquid to each nozzle in each nozzle set is controlled by a mass flow controller that is connected in series between the manifold and the particular nozzle. Each mass flow controller includes a measurement unit, such as a flow meter, and an associated actuation unit, such as a valve.

The thickness of the material deposited by each printer nozzle is critical. Small deviations in the flow rate of liquid dispensed from one nozzle with respect to the flow rate of liquid dispensed from the other nozzles can create visible defect patterns in the finished display. As such it is of paramount importance that the all of the mass flow controllers output identical flow rates.

The liquid flow rate through a flow meter in a mass flow controller is not directly measured, but is instead indirectly inferred based upon various calibration parameters that are themselves based upon various properties of the liquid (as, for example, heat capacity and density). These properties and the calibration parameters are themselves highly susceptible to environmental influences, such as temperature. Moreover, the meter typically relies on internal analog circuitry to calculate the flow rate based on the property measurements. These components are prone to noise and drift, requiring that the meter in each flow controller undergo frequent calibration.

Calibration of the flow meter in each mass flow controller in the system is typically done with a master flow meter using a “bucket and stopwatch” approach. Liquid passing through the master flow meter for a predetermined period of time is collected and precisely measured using an analytical balance. The volume of liquid as recorded by the analytical balance is compared to the volume of material as recorded by the master flow meter. The master flow meter is adjusted to account for any variation. Once so calibrated the master flow meter is itself used to calibrate the flow meter in each mass flow controller in the system.

This “bucket and stopwatch” approach is believed disadvantageous for a number of reasons.

The determination of the flow rate by the master flow meter is itself an indirect measurement, subject to the same inaccuracies and shortcomings as discussed previously. Also, the allowed variation (error) in measurement for the master flow meter is close to an acceptable process deviation. Thus, using the master flow meter to create an indirect measurement that is subject to an error range that is close to an acceptable product specification, and then using that indirect measurement to calibrate the other flow meters multiplies the calibration error for the overall system. On another level, with the prior art technique only one nozzle can be calibrated at a time. Since calibration is a time-consuming process, and since the calibration must be performed while the given flow meter is off-line, calibrating the flow meters at the optimal calibration frequency may be cost prohibitive.

Accordingly, in view of the foregoing it is believed desirable to provide an alternative method of calibration for the flow meter in each of the mass flow controllers in a system that relies upon a direct flow rate measurement. It is also believed to be advantageous to provide a calibration arrangement that can adjust a plurality of flow meters in a more time-efficient manner.

### SUMMARY OF THE INVENTION

In accordance with the system and method of the present invention a positive displacement pump is used to create a more accurate direct measurement of liquid flow rate and to use this more accurate direct measurement to adjust the calibration parameters of the flow meter in each of the mass flow controllers in a system substantially simultaneously.

### BRIEF DESCRIPTION OF THE DRAWINGS

The invention will be more fully understood from the following detailed description, taken in connection with the accompanying drawings, which form a part of this application and in which:

FIG. 1 is a highly stylized pictorial representation of a calibration system in accordance with the present invention for continuously calibrating mass flow controllers in an apparatus for dispensing a liquid composition on a backplane; and

FIG. 2 is a highly stylized pictorial representation in horizontal section showing a positive displacement calibration tool in accordance with another aspect of the present invention.

### DETAILED DESCRIPTION OF THE INVENTION

Throughout the following detailed description similar reference characters refers to similar elements in all figures of the drawings.

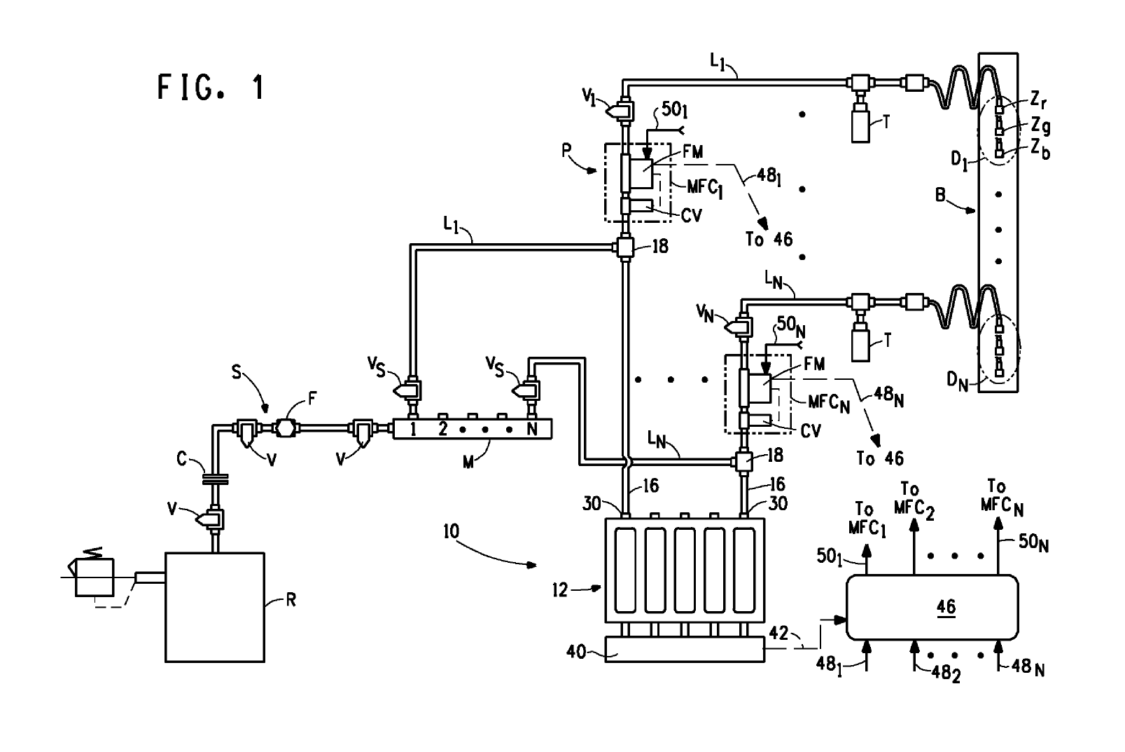

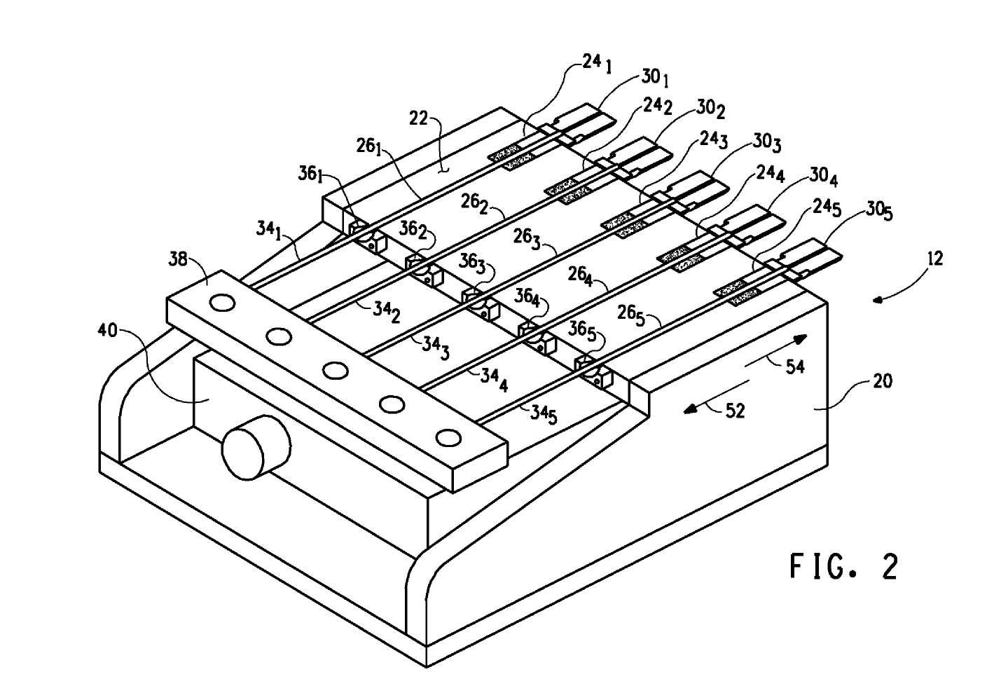

FIG. 1 is a highly stylized pictorial representation of a calibration system generally indicated by the reference character 10 in accordance with the present invention useful for implementing a method also in accordance with the present invention for continuously calibrating the flow meter in each mass flow controller in a printing apparatus P for dispensing a liquid composition on a backplane. The system and the method both utilize a highly accurate positive displacement calibration tool generally indicated by the reference character 12 in accordance with yet another aspect of the present invention. A detailed view of the calibration tool 12 is shown in FIG. 2.

As mentioned earlier, in a standard configuration the printing apparatus P with which the invention is utilized includes a dispensing bar that carries a plurality of sets of dispensing nozzles. Elements of the printing apparatus P common to the prior art are indicated herein by alphabetic reference characters.

FIG. 1 diagrammatically illustrates a dispensing bar B that carries N sets of dispensing nozzles, respectively indicated by the reference characters D₁, . . . D_{N}. Typically, a bar may carry five or more nozzle sets. Each nozzle set D includes a separate nozzle that discharges one of a plurality of different colored liquid compositions. Typically, each nozzle set D may contain a nozzle Zᵣ, Z_{g}, and Z_{b} respectively dispensing a red, a green and a blue liquid composition. The printing apparatus P is useful in the fabrication of various organic electronic devices, and is believed to be especially useful to fabricate screens for variously sized display devices, including high density display devices.

The nozzle in each nozzle set for a given color are supplied as a group from a communal pressurized supply reservoir for the particular colored liquid composition. FIG. 1 graphically illustrates a diagram of the plumbing between a communal dispensing vessel R holding the liquid supply and the nozzles in one given nozzle group (e.g., the group of nozzles Zᵣ for the red color liquid). The plumbing arrangement for each nozzle in the other nozzle groups would be identical.

The communal supply vessel R is connected over a supply line S to a manifold M. The line S may typically include standard appurtenances such as valves V, filter(s) F and/or connector(s) C, as suggested.

A given outlet port 1, 2, . . . N from the manifold M is connected to a respective nozzle in each nozzle set through a dedicated line L₁, . . . L_{N}. A portion of the line L adjacent to the nozzle is flexible, as suggested in the drawing. Each line L includes a mass flow controller MFC that measures the mass flow rate of the liquid to the nozzle. Each mass flow controller MFC itself includes a flow meter FM and a control valve CV. It is the flow meter FM in each line L that requires calibration to insure that the proper amount of liquid is dispensed through the nozzle and deposited on a backplane. A pressure transducer T may be provided adjacent to the fitting connecting the rigid and the flexible portions of each line L. Flow from the manifold M into each supply line L is controlled by a supply valve V_{S} while an isolation valve V_{I} serves to separate the mass flow controller MFC from the nozzle.

In accordance with the present invention the calibration system 10 includes the positive displacement calibration tool 12. A representative embodiment of a calibration tool 12 for a printing apparatus having five nozzle groups (N=5) is shown in FIG. 2. The calibration tool 12 includes a frame 20 that carries a unitary chamber block 22. The block is fabricated from a material, such as stainless steel (e.g., 304 stainless steel) that is compatible with the liquid composition. A plurality of cylinders, or fluid chambers, 24₁ . . . 24₅ and respective coaxial counterbored guide channels 26₁ . . . 26₅ are bored into the block 22. The axis of each chamber 24 is aligned within predetermined precise tolerance (on the order of +/−0.0001 inches) with the axis of each of the other chambers. A respective fitting 30₁ . . . 30₅ is coupled to the outlet of each chamber 24₁ . . . 24₅. In accordance with the present invention each chamber is connected in series to a flow meter in a respective mass flow controller through a respective flow line 16 and a junction 18 (FIG. 1).

A piston in the form of an elongated displacer rod 34₁ . . . 34_{N} (FIG. 2) projects rearwardly from within a respective chamber and is guided in a respective guide channel 26₁ . . . 26₅ formed in the block 22. Each displacer rod 34 is a hardened and ground linear bearing shaft. Sealed integrity between the rod and its associated chamber 22 is maintained by a seal 36. Preferably, each displacer rod is within a predetermined close tolerance (on the order of +/−0.0001 inches) of the dimension of each of the other displacer rods. Of course, it is understood that any suitable piston configuration may be used.

The free end of each of the rods 34₁ . . . 34₅ is rigidly connected to a mounting yoke 38. The yoke 38 is itself connected to the carriage of an actuator 40. Preferable for use as the actuator 40 is the linear encoder with tachometer feedback available from Newport Corporation as the motorized linear translation stage VP25XA (0.05 micrometer positioning accuracy with 25.4 mm stroke length).

Referring again to FIG. 1 the output from the linear encoder is connected over a signal line 42 to a control network 46. In addition, an output signal from the flow meter FM in each of the meters mass flow controllers MFC₁ . . . MFC_{N} is carried to the control network 46 over a respective signal line 48₁ . . . 48_{N}. A control output from the network 46 is applied to the flow meter FM in each flow controller over a respective control line 50₁ . . . 50_{N}.

The system and method in accordance with the present invention are operative to calibrate the flow meter FM in each of the mass flow controllers MFC₁ . . . MFC_{N} to correct for the inherent measurement inaccuracies in those instruments.

With each supply valve V_{S} open and each isolation valve V_{I} in each supply line S₁ . . . S_{N} closed the yoke 38 and the rods 34 attached thereto are withdrawn (in the retraction direction of the arrow 52, FIG. 2) from their associated chambers 24 by the actuator 40. This action permits liquid from the supply vessel R to flow via the manifold M and the open supply valve V_{S} into a chamber in the calibration tool 12.

The states of the supply valves V_{S} isolation valves V_{I} are reversed so that the tool 12 is connected in open fluid communication with the each flow controller and its associated nozzle while being simultaneously isolated from the liquid supply R. The actuator 40 then displaces the yoke 38 to advance each of the rods 34 in unison in the dispensing direction of the arrow 54 (FIG. 2). The forward face of each rod 34 as it advances through its associated chamber acts as a movable abutment that forces a predetermined precise volume of liquid at a precise flow rate through the line 16, through the meter and to the nozzle.

The signal from the linear encoder is applied over the line 42 to the control network. The high machined accuracy of the rod and chamber, coupled with the precise information regarding the displacement of the rods enables the control network to generate a direct measurement of the volumetric flow rate of the liquid dispensed by the pump. (It should be noted that the fact that the dimension of a given displacer rod may lie outside of the defined tolerance range need not be overly detrimental to the operation of the system. Any difference in flow caused by an out-sized displacer rod would repeatably appear from calibration to calibration, and the discrepancy accounted for by the controller 46.)

The control network 46 is operative to compare the volumetric flow rate precisely dispensed from the pump (the signal on the line 42) to a volumetric flow rate measured by a particular meter FM (the signal on that meter's output line 48) and to provide a correction signal (on a given line 50) that modifies the calibration parameters of that particular meter FM in accordance with the flow rate dispensed from the pump. The functionality of the control network 46 may be implemented using the overall controller for the printer P, or by using a dedicated processor (e.g., a personal computer such as a Dell® Inspiron® computer) operating in accordance with an appropriate program).

The apparatus and method of the present invention is believed superior to the calibration techniques employed by the prior art in a variety of particulars. The calibration system utilizes a positive displacement pump that directly measures the liquid being provided to each flow meter. The calibration of all of the flow meters is accomplished while the positive displacement pump is connected to each flow meter, (thus, the pump is not operated off-line of the meter being calibrated, as is the case in the “bucket and stopwatch” approach in the art). Moreover, since all of the meters are calibrated simultaneously, overall time required for calibration of all of the meters is minimized.

Those skilled in the art, having the benefit of the teachings of the present invention, may impart modifications thereto. Such modifications are to be construed as lying within the scope of the present invention, as defined by the appended claims.

What is claimed is:

1. A positive displacement calibration tool useful for simultaneously calibrating a plurality of flow meters in a printing apparatus, the tool comprising:
a frame;
a housing block having a plurality of fluid chambers therein, each fluid chamber being connectible to a respective liquid flow line, each chamber having an axis therethrough, the axis of each fluid chamber being aligned within a predetermined close tolerance with the axis of each of the other fluid chambers formed in the block;
a piston mounted within the block for movement within each fluid chamber; and
an actuator connected to all of the pistons whereby the actuator is operative to displace each piston through its associated chamber to cause a precisely dispensed predetermined flow rate of a liquid to pass simultaneously from each chamber.

2. The positive displacement calibration tool of claim 1 wherein the piston comprises an elongated displacer rod.

3. The positive displacement calibration tool of claim 1 wherein the actuator includes a linear encoder with tachometer feedback.
